(19) United States
(12) Patent Application Publication
(10) Pub. No.: US 2004/0002569 A1
(43) Pub. Date: Jan. 1, 2004

(54) Composite material of polyolefin resin and filler and molded article made from the same

(75) Inventors: Katsuhisa Kitano, Ichihara-shi (JP); Takashi Sanada, Ichihara-shi (JP)

Correspondence Address: SUGHRUE MION, PLLC, 2100 Pennsylvania Avenue, NW, Washington, DC, 20037-3213, US

(73) Assignee: SUMITOMO CHEMICAL COMPANY, LIMITED

(21) Appl. No.: 10/456,682

(22) Filed: Jun. 9, 2003

(30) Foreign Application Priority Data
Jun. 13, 2002 (JP) 2002-172533
Oct. 21, 2002 (JP) 2002-305544

(51) Int. Cl. C08L 23/00

(52) U.S. Cl. 524/494; 525/301; 525/302

(57) ABSTRACT

Disclosed are a composite material containing (A) a modified polyolefin resin graft-modified with an unsaturated carboxylic acid and/or its derivative and (B) a filler, wherein a content of the component (B) is from 1 to 80 parts by weight based on 100 parts by weight of a combined content of the components (A) and (B), a graft amount of the unsaturated carboxylic acid and/or its derivative in the component (A) is 0.3% by weight or more, and the component (A) has a melt flow rate as measured at 230° C. and a load of 21.2 N of 400 g/10 min or less and a composite material further containing (C) a polyolefin resin.

### BACKGROUND OF THE INVENTION

1. Field of the Invention

The present invention relates to a composite material of a polyolefin resin and a filler, and to a molded article obtained from the same. More particularly, the invention relates to a composite material of a polyolefin resin and a filler superior in mechanical strength, e.g. stiffness and impact strength, and also in endurance, e.g. fatigue strength, and to a molded article obtained from the same.

2. Description of the Related Art

Polyolefin resin is in wide use as a general purpose resin because it is superior in moldability and chemical resistance and has a low specific gravity. As an approach for improving mechanical strength, e.g. stiffness and impact strength, of polyolefin resin, known is incorporation of fillers such as talc, mica and glass fiber. See JP-A-10-176085.

As an approach for further improvement in mechanical strength, e.g. stiffness and impact strength, of a composition of a polyolefin resin and a filler, known is a method of enhancing the adhesiveness between a polyolefin resin and a filler, for example, a method comprising addition of a modified polyolefin resin to a composition of a polyolefin and a filler. In general, a method is used in which a polypropylene resin in a molten state is graft-modified with an unsaturated carboxylic acid and/or its derivative by means of an initiator such as organic peroxide or irradiation of ultraviolet rays or radiation.

However, for increasing the graft amount in order to greatly improve the adhesiveness between the polyolefin resin and the filler, it is necessary to use a great amount of initiator. This may cause decrease in molecular weight of the polyolefin resin, which may result in decrease in mechanical strength, e.g. stiffness and impact strength, of a polyolefin resin composition and also may result in poor endurance, e.g. fatigue characteristic.

### SUMMARY OF THE INVENTION

An object of the present invention is to provide a composite material of a polyolefin resin and a filler, the composite material being superior in mechanical strength, e.g. stiffness and impact strength, and also in endurance, e.g. fatigue strength, and a molded article superior in mechanical strength, e.g. stiffness and impact strength, and also in endurance, e.g. fatigue strength.

In a first aspect, the present invention relates to

a composite material comprising (A) a modified polyolefin resin graft-modified with an unsaturated carboxylic acid and/or its derivative and (B) a filler, wherein a content of the component (B) is from 1 to 80 parts by weight based on 100 parts by weight of a combined content of the components (A) and (B), a graft amount of the unsaturated carboxylic acid and/or its derivative in the component (A) is 0.3% by weight or more, and the component (A) has a melt flow rate as measured at 230° C. and a load of 21.2 N of 400 g/10 min or less, and a molded article obtained from the same.

In a second aspect, the present invention relates to

a composite material comprising (A) a modified polyolefin resin graft-modified with an unsaturated carboxylic acid and/or its derivative, (B) a filler and (C) a polyolefin resin, wherein a weight ratio of the component (C) to the component (A) is from 99.9/0.1 to 60/40, a content of the component (B) is from 1 to 80 parts by weight based on 100 parts by weight of a combined content of the components (A), (B) and (C), a graft amount of the unsaturated carboxylic acid and/or its derivative in the component (A) is 0.3% by weight or more, and the component (A) has a melt flow rate as measured at 230° C. and a load of 21.2 N of 400 g/10 min or less, and a molded article obtained from the same.

### DESCRIPTION OF PREFERRED EMBODIMENTS

The modified polyolefin resin (A) may be a modified polyolefin resin obtained by kneading a polyolefin resin together with an unsaturated carboxylic acid and/or its derivative while heating. The polyolefin resin used for preparation of the component (A) may be the same as or different than a polyolefin resin (C), which will be described later. In view of heat resistance, polypropylene resin is preferable as the polyolefin resin used for the component (A).

A graft amount of the unsaturated carboxylic acid and/or its derivative in the modified polyolefin resin (A) is 0.3% by weight or more. When the graft amount is less than 0.3% by weight, endurance, e.g. fatigue strength, may be reduced. In view of endurance, e.g. fatigue strength, and moldability, the graft amount is preferably from 0.3 to 20% by weight, more preferably from 0.4 to 20% by weight, and particularly preferably from 0.5 to 10% by weight. It is noted that the graft amount is a value quantified from the absorption caused by the unsaturated carboxylic acid and/or its derivative in an infrared absorption spectrum of the modified polyolefin resin. The method for quantifying a graft amount by use of an infrared spectrum in the present invention is described in Fumio IDE et al., “High Polymer Chemistry”, Vol. 25, 107-115 (1968) and Fumio Ide et al., “Kobunshi Ronbunshu (Japanese Journal of Polymer Science and Technology)”, Vol. 38, No. 2, 67-74 (1981).

It is desirable that the modified polyolefin resin (A) contain no unsaturated carboxylic acid and/or its derivative used for its graft modification. However, the modified polyolefin resin (A) may contain unsaturated carboxylic acid and/or its derivative if in a small quantity. Even if such an unreacted monomer used for graft modification remains in the modified polyolefin resin (A), the amount thereof is preferably 0.3% or less, more preferably 0.2% or less, still more preferably 0.1% base on the weight of the modified polyolefin resin (A).

A melt flow rate (MFR) of the modified polyolefin resin (A) is 400 g/10 min or less. When the MFR is over 400 g/10 min, the mechanical strength may be lowered. In view of mechanical strength and production stability, the MFR is preferably from 5 to 400 g/10 min, more preferably from 10 to 200 g/10 min, and particularly preferably from 20 to 90 g/10 min. It is noted that the MFR is a value measured at a temperature of 230° C. at a load of 21.2 N according to ASTM D1238.

The modified polyolefin resin (A) is preferably a modified polypropylene resin produced by compounding an unsaturated carboxylic acid and/or its derivative (D), described later, and an organic peroxide (E) the decomposition temperature of which is from 50 to 120° C. when its half-life is 1 minute, described layer, to a polypropylene resin and kneading them while heating.

The compounding amount of the unsaturated carboxylic acid and/or its derivative (D) is from 0.1 to 20 parts by weight, preferably from 0.5 to 10 parts by weight based on 100 parts by weight of the polypropylene resin. When the compounding amount of the component (D) is less than 0.1 part by weight, a sufficient graft amount to the polypropylene resin may not be achieved and the mechanical strength may not be improved. On the other hand, when it is over 20 parts by weight, much unsaturated carboxylic acid and/or its derivative may be left unreacted in the polypropylene resin and the mechanical strength may not be improved. When two or more kinds of unsaturated carboxylic acid and/or its derivative are compounded as the component (D), the compounding amount of the component (D) denotes a combined amount of these substances.

The compounding amount of the organic peroxide (E) the decomposition temperature of which is from 50 to 120° C. when its half-life is 1 minute is from 0.01 to 20 parts by weight, preferably from 0.02 to 10 parts by weight based on 100 parts by weight of the polypropylene resin. When the compounding amount of the component (E) is less than 0.01 part by weight, a sufficient graft amount to the polypropylene resin may not be achieved and the effect of improving the mechanical strength may not be obtained. On the other hand, when it is over 20 parts by weight, crosslinking of the resin may occur or decomposition of the resin may be accelerated. This may reduce the production stability.

The modified polyolefin resin (A) is more preferably a modified polypropylene resin produced by compounding an unsaturated carboxylic acid and/or its derivative (D), described later, an organic peroxide (E) the decomposition temperature of which is from 50 to 120° C. when its half-life is 1 minute and an organic peroxide (F) the decomposition temperature of which is from 150 to 200° C. when its half-life is 1 minute, described layer, to a polypropylene resin and kneading them while heating.

The compounding amount of the unsaturated carboxylic acid and/or its derivative (D) is from 0.1 to 20 parts by weight, preferably from 0.5 to 10 parts by weight based on 100 parts by weight of the polypropylene resin.

When the compounding amount of the component (D) is less than 0.1 part by weight, a sufficient graft amount to the polypropylene resin may not be achieved and the mechanical strength may not be improved. On the other hand, when it is over 20 parts by weight, much unsaturated carboxylic acid and/or its derivative may be left unreacted in the polypropylene resin and the mechanical strength may not be improved. When two or more kinds of unsaturated carboxylic acid and/or its derivative are compounded as the component (D), a compounding amount of the component (D) denotes a combined amount of these substances.

The compounding amount of the organic peroxide (E) the decomposition temperature of which is from 50 to 120° C. when its half-life is 1 minute is from 0.01 to 20 parts by weight, preferably from 0.02 to 10 parts by weight based on 100 parts by weight of the polypropylene resin. When the compounding amount of the component (E) is less than 0.01 part by weight, a sufficient graft amount to the polypropylene resin may not be achieved and the effect of improving the mechanical strength may not be obtained. On the other hand, when it is over 20 parts by weight, the production stability may be reduced.

The compounding amount of the organic peroxide (F) the decomposition temperature of which is from 150 to 200° C. when its half-life is 1 minute is from 0.01 to 20 parts by weight, preferably from 0.02 to 10 parts by weight based on 100 parts by weight of the polypropylene resin. When the compounding amount of the component (F) is less than 0.01 part by weight, an effect of increasing the graft amount of the unsaturated acid and/or its derivative to the polypropylene resin may be poor and the effect of improving the mechanical strength may not be obtained. On the other hand, when it is over 20 parts by weight, decomposition of the polypropylene resin may be accelerated.

The modified polyolefin resin (A) can be prepared by kneading an unmodified polyolefin resin and substances selected from the components (D), (E) and (F) at a proper temperature in a temperature-controllable kneading apparatus. For example, a method may be employed in which all the ingredients are mixed at a time or sequentially to form a homogeneous mixture and the mixture is then melt kneaded. When obtaining the homogeneous mixture by mixing the ingredients at a time or sequentially, it is possible to mix some ingredients to form a mixture in advance and then mix the mixture with other ingredients or a mixture thereof. A method for obtaining the homogeneous mixture may be a method of homogeneously mixing with a Henschel mixer, a blender such as a ribbon blender, or the like. A method of melt kneading may be a melt kneading method using a Banbury mixer, a plastomill, a Brabender plastograph, a single screw or twin screw extruder, or the like.

From the viewpoint of being capable of performing continuous production with a high productivity, particularly preferred is a method in which a polyolefin resin, an unsaturated carboxylic acid compound and/or its derivative (D) and organic peroxides (E) and (F), which have in advance been fully mixed preliminarily, are charged to a single or twin screw extruder and melt kneaded.

A temperature in a portion of a kneading machine where the kneading is carried out (for example, cylinder temperature of an extruder) is from 50 to 300° C., preferably from 100 to 250° C. from the viewpoint of achieving a high graft amount or preventing decomposition of the polyolefin resin. It is also a preferred embodiment in which the inside of a kneading machine is divided into an upstream portion and a downstream portion and the temperature in the downstream portion is set higher than that of the upstream portion.

For achieving a sufficient graft amount or preventing decomposition of the polyolefin resin, a kneading time is from 0.1 to 30 minutes and particularly preferably from 0.5 to 5 minutes.

In order to prevent generation of odor during the production of the modified olefin resin (A), it is preferable not to incorporate an electron-donating compound such as styrene and divinylbenzene.

When the modified polyolefin resin (A) is produced, known substances which are generally added to polyolefin resin, for example, antioxidants, heat stabilizers and neutralizing agents may be compounded.

The filler (B) is a substance capable of reinforcing the polyolefin resin and is exemplified by fibers, glass flakes, mica, glass powders, glass beads, talc, clay, alumina, silica, wollastonite, kaolin, asbestos, bentonite, calcium silicate, aluminumsilicate, sand, diatomite, titaniumoxide, ironoxide, aluminum oxide, magnesium oxide, antimony oxide, barium ferrite, strontium ferrite, berylliumoxide, pumice, magnesiumhydroxide, aluminum hydroxide, basic magnesium carbonate, calcium carbonate, magnesium carbonate, dolomite, dawsonite, calcium sulfate, magnesium sulfate, calcium sulfite, carbon black, molybdenum sulfide, magnet powder, cadmium sulfide, whisker, wood flour, bamboo powder, and melamine powder. In the present invention, one kind of filler may be used or alternatively two or more kinds of fillers may be used in combination.

From the viewpoint of reinforcing effect, a particularly preferable filler (B) is fiber, examples of which include glass fibers, carbon fibers, polyester fibers, metal fibers, aromatic polyamide fibers, bamboo fibers, cellulose fibers, kenaf fibers and vinylon fibers. Among these preferred are glass fibers.

When using fibers as the filler (B), a binder may be used in order to bind the fibers. Examples of the binder include polyolefin resin, polyurethane resin, polyester resin, acrylic resin, epoxy resin, starch and vegetable oil. Moreover, acid-modified polyolefin resin, surface treating agents and lubricants such as paraffin wax may also be incorporated.

When using fibers as the filler (B), the fibers may be treated with a surface treating agent in advance in order to improve wettability or adhesiveness of the fibers to the polyolefin resin. The surface treating agent may be coupling agents of silane-type, titanate-type, aluminum-type, chromium-type, zirconium-type and borane-type. Preferred are silane-type coupling agents and titanate-type coupling agents. Particularly preferred are silane-type coupling agents.

Examples of the silane-type coupling agent include triethoxysilane, vinyltris(β-methoxyethoxy)silane, γ-methacryloxypropyltrimethoxysilane, γ-glycidoxypropyltrimethoxysilane, β-(3,4-epoxycyclohexyl)ethyltrimethoxysilane, N-β-(aminoethyl)-γ-aminopropyltrimethoxysilane, N-β-(aminoethyl)-γ-aminopropylmethyldimethoxysilane, γ-aminopropyltriethoxysilane, N-phenyl-γ-aminopropyltrimethoxysilane, γ-mercaptopropyltrimethoxysilane, and γ-chloropropyltrimethoxysilane. Among these, preferred are aminosilanes such as γ-aminopropyltriethoxysilane and N-β-(aminoethyl)-γ-aminopropyltrimethoxysilane.

As a method of treating the aforementioned fibers with the surface treating agent may be a method conventionally used, e.g. an aqueous solution method, an organic solvent method and a spray method.

From the viewpoint of improving mechanical strength such as stiffness and impact strength or ease to producing or molding a composite material, a weight-average length of the fibers in a composite material of the present invention is preferably 2 mm or more, more preferably from 2 to 50 mm, and still more preferably from 3 to 50 mm. It is noted that the weight-average length of the fibers used herein denotes a weight-average fiber length determined by the measuring method described in JP-A-2002-5924.

In the composite material of the present invention, it is preferable that the fibers have a weight-average length of 2 mm or more and it is also preferable that the fibers be arranged substantially in parallel with each other in the composite material. In particular, for obtaining a molded article which holds a superior strength without damaging injection moldability by an injection molding technique whose molding operation is easy, it is preferable that the composite material be in the form of pellet having a length of from 2 to 50 mm and the fibers have a weight-average length equal to the length of the pellet.

Examples of the polyolefin resin (C) include polypropylene resins, and polyethylene resins, e.g. ethylene homopolymers and ethylene-α-olefin random copolymers. One kind of polyolefin resin may be used as the component (C) or alternatively two or more kind of polyolefin resins may be used in combination. The polyolefin resin (C) is preferably a polypropylene resin.

Examples of the polypropylene resin (C) include propylene homopolymers, ethylene-propylene random copolymers, propylene-α-olefin random copolymers, and composite polymers obtained by homopolymerizing propylene and subsequently copolymerizing ethylene and propylene to form an ethylene-propylenecopolymerportion. In the present invention, one kind of polypropylene resin may be used or alternatively two or more kinds of polypropylene resins may be used in combination.

Examples of the α-olefin include 1-butene, 2-methyl-1-propene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, methyl-1-hexene, dimethyl-1-pentene, ethyl-1-pentene, trimethyl-1-butene, methylethyl-1-butene, 1-octene, methyl-1-pentene, ethyl-1-hexene, dimethyl-1-hexene, propyl-1-heptene, methylethyl-1-heptene, trimethyl-1-pentene, propyl-1-pentene, diethyl-1-butene, 1-nonene, 1-decene, 1-undecene and 1-dodecene. Among these, preferred are 1-butene, 1-pentene, 1-hexene and 1-octene.

A process for producing the polypropylene resin (C) may be any of the processes of solution polymerization, slurry polymerization, bulk polymerization and gas phase polymerization described in “New Polymer Production Process (edited by YASUJI SAEKI, KOGYO CHOSAKAI PUBLISHING CO. (1994)), JP-A-4-323207 and JP-A-61-287917. These methods may be employed in combination.

A catalyst to be used in the production of the polyolefin resin (C) maybe chosen from various known catalysts. Preferred are a multiple site catalyst obtained by use of a solid catalyst component containing a titanium atom, a magnesium atom and a halogen atom, and a single site catalyst obtained by use of a metallocene complex or the like.

Examples of the unsaturated carboxylic acid and/or its derivative (D) include (I) a compound having in the molecule both (i) at least one kind of unsaturated group and (ii) at least one kind of carboxylic acid group and/or group derived from a carboxylic acid, and (II) a compound capable of changing its structure through dehydration during a production process to a structure having in the molecule both (i) at least one kind of unsaturated group and (ii) at least one kind of carboxylic acid group and/or group derived from a carboxylic acid.

Examples of the unsaturated group (i) include a carbon-carbon drouble bond and a carbon-carbon triple bond. Examples of the carboxylic acid group and/or group derived from a carboxylic acid (ii) include a carboxylic acid group, various kinds of salts, esters, acid amides, acid anhydrides, imides, acid azides, and acid halides resulting from substitution of the hydrogen atom or hydroxy group in a carboxyl group.

Examples of the compound (I) having in the molecule both an unsaturated group (i) and a carboxylic acid group and/or group derived from a carboxylic acid (ii) include unsaturated carboxylic acids, derivatives of unsaturated carboxylic acids, compounds capable of producing an unsaturated carboxylic acid or a derivative of a carboxylic acid through dehydration during a process of grafting to a polyolefin resin.

Examples of the unsaturated carboxylic acids include maleic acid, fumaric acid, itaconic acid, acrylic acid and methacrylic acid. Examples of the derivatives of carboxylic acids include maleic anhydride, itaconic anhydride, methyl acrylate, ethyl acrylate, butyl acrylate, glycidyl acrylate, methyl methacrylate, ethyl methacrylate, butyl methacrylate, glycidyl methacrylate, maleic acid monoethyl ester, maleic acid diethyl ester, fumaric acid monomethyl ester and fumaric acid dimethyl ester. Among these unsaturated carboxylic acids and/or their derivatives, preferred are glycidyl esters of acrylic acid and methacrylic acid, and maleic anhydride.

Examples of the compounds for producing an unsaturated carboxylic acid or a derivative of a carboxylic acid through dehydration during a process of grafting to a polyolefin resin include citric acid and malic acid.

For achieving a large graft amount and preventing decomposition of the polyolefin resin, the decomposition temperature of the organic peroxide (E) when its half-life is 1 minute is from 50 to 120° C., preferably from 70 to 110° C. A compound having an activity of extracting a proton from the polypropylene resin after decomposing to form a radical is preferable as the organic peroxide (E).

Examples of the organic peroxide (E) the decomposition temperature of which is from 50 to 120° C. when its half-life is 1 minute include diacylperoxide compounds, percarbonate compounds, e.g. a compound having a structure represented by structural formula (1) shown below in the molecular backbone, and alkyl perester compounds, e.g. a compound having a structure represented by structural formula (2) shown below.

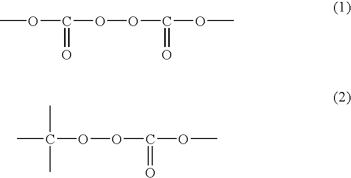

Examples of the compound having a structure represented by structural formula (1) include di-3-methoxybutylperoxydicarbonate, di-2-ethylhexylperoxydicarbonate, bis(4-tert-butylcyclohexyl)peroxydicarbonate, diisopropylperoxydicarbonate, tert-butylperoxyisopropylcarbonate, and dimyristyleroxycarbonate.

Examples of the compound having a structure represented by structural formula (2) include 1,1,3,3-tetramethylbutyl neodecanoate, α-cumyl peroxyneodecanoate, and tert-butyl peroxyneodecanoate.

Among these organic peroxides, preferred are percarbonate compounds (compounds having a structure represented by structural formula (1) in their molecular backbones) having an activity of extracting a proton from a polyolefin resin.

From the viewpoint of increasing the graft amount, the decomposition temperature of the organic peroxide (F) when its half-life is 1 minute is from 150 to 210° C., preferably from 160 to 200° C.

Examples of the organic peroxide (F) the decomposition temperature of which is from 150 to 210° C. when its half-life is 1 minute include 1,1-bis(tert-butylperoxy)cyclohexane, 2,2-bis(4,4-di-tert-butylperoxycyclohexyl)propane, 1,1-bis(tert-butylperoxy)cyclododecane, tert-hexylperoxyisopropylmonocarbonate, tert-butylperoxy-3,5,5-trimethylhexanoate, tert-butylperoxylaurate, 2,5-dimethyl-2,5-di(benzoylperoxy)hexane, tert-butylperoxyacetate, 2,2-bis(tert-butylperoxy)butene, tert-butylperoxybenzoate, n-butyl-4,4-bis(tert-butylperoxy)valerate, di-tert-butylperoxyisophthalate, dicumylperoxide, α,α′-bis(tert-butylperoxy-m-isopropyl)benzene, 2,5-dimethyl-2,5-di(tert-butylperoxy)hexane, 1,3-bis(tert-butylperoxydiisopropyl)benzene, tert-butylcumylperoxide, di-tert-butylperoxide, p-methanehydroperoxide, and 2,5-dimethyl-2,5-di(tert-butylperoxy)hexyne-3.

In the composite material according to the first aspect of the present invention, that is, the composite material containing the modified polyolefin resin (A) and the filler (B), the content of the component (B) is from 1 to 80 parts by weight, preferably from 2 to 75 parts by weight, and more preferably from 5 to 70 parts by weight based on 100 parts by weight of the combined amount of the components (A) and (B). When the content of the component (B) is less than 1 part by weight, a sufficient reinforcing effect to mechanical strength, e.g. stiffness and impact strength, may not be obtained. On the other hand, when it is over 80 parts by weight, it may be difficult to produce or mold a composite material.

In the composite material according to the second aspect of the present invention, that is, the composite material containing the modified polyolefin resin (A), the filler (B) and the polyolefin resin (C), the content of the component (B) is from 1 to 80 parts by weight, preferably from 2 to 75 parts by weight, and more preferably from 5 to 70 parts by weight based on 100 parts by weight of the combined amount of the components (A), (B) and (C). When the content of the component (B) is less than 1 part by weight, a sufficient reinforcing effect to mechanical strength, e.g. stiffness and impact strength, may not be obtained. On the other hand, when it is over 80 parts by weight, it may be difficult to produce or mold a composite material.

When the polyolefin resin (C) is used, a weight ratio of the polyolefin resin (C) to the modified polyolefin resin (A) in the composite material of the present invention is from 99.9/0.1 to 60/40, preferably from 99.5/0.5 to 70/30, and more preferably from 99.0/1.0 to 80/20 in view of endurance, e.g. fatigue characteristics, and mechanical strength, e.g. stiffness and impact strength.

In order to impart a desired characteristic, known substances which are generally added to polyolefin resin, for example, nucleating agents, crystallization accelerators, antioxidants, heat stabilizers, neutralizing agents, stabilizers such as ultraviolet absorbers, foam inhibitors, flame retarders, flame retarding aids, dispersing agents, antistatic agents, lubricants, antiblocking agents such as silica, colorants such as dyestuffs and pigments, plasticizers, and rubber may, as required, be incorporated to the composite material of the present invention.

Examples of a method for producing the composite material of the present invention include a method in which all the ingredients are mixed at a time or sequentially to form a homogeneous mixture and the mixture is then melt kneaded and a pultrusion process. When obtaining the homogeneous mixture by mixing the ingredients at a time or sequentially, it is possible to mix some ingredients to form a mixture in advance and then mix the mixture with other ingredients or a mixture thereof. A method for obtaining the homogeneous mixture may be a method of homogeneously mixing with a Henschel mixer, a blender such as a ribbon blender, or the like. A method of melt kneading may be a method using a Banbury mixer, a plastomill, a Brabender plastograph, a single screw or twin screw extruder, or the like.

The pultrusion process is a method which basically comprises impregnating continuous fiber strands with resin while pulling the fiber strands, examples of which include one that comprises impregnating fiber strands with resin by passing the strands through an impregnation pan containing emulsion, suspension or solution of the resin, one that comprises blowing resin powder against fiber strands and then melting the resin to impregnate the fiber strands with the resin, one that comprises passing fiber strands through a vessel containing resin powder, thereby to attach the resin to the fiber, and then melting the resin to impregnate the fiber strands with the resin, and one that comprises, while passing fiber strands through a cross head, feeding resin from an extruder or the like to the cross head thereby to effect impregnation. Particularly preferred is a method that uses a cross head described in JP-A-3-272830 and other literature. The operation of impregnation with resin in such a pultrusion process maybe done in one step or alternatively in two or more separate steps.

More specifically, the composite material according to the first aspect of the present invention can be produced by a method having the steps (1) to (3) defined below:

(1) a step of melt kneading (A) a modified polyolefin resin graft-modified with an unsaturated carboxylic acid and/or its derivative, the modified polyolefin resin having a graft amount of the unsaturated carboxylic acid and/or its derivative of 0.3% by weight or more and a melt flow rate as measured at 230° C. and a load of 21.2 N of 400 g/10 min;

(2) a step of impregnating (B)a continuous filler with the molten component (A) obtained in step (1) so that a content of the component (B) becomes from 1 to 80 parts by weight based on 100 parts by weight of a combined content of the components (A) and (B), thereby forming a continuous strand; and

(3) a step of cutting the continuous strand formed in step (2).

The composite material according to the second aspect of the present invention can be produced by a method having the steps (1) to (3) defined below:

(1) a step of melt kneading (A) a modified polyolefin resin graft-modified with an unsaturated carboxylic acid and/or its derivative and (C) a polyolefin resin (C) so that a weight ratio of the component (C) to the component (A) becomes from 99.9/0.1 to 60/40, the modified polyolefin resin (A) having a graft amount of the unsaturated carboxylic acid and/or its derivative of 0.3% by weight or more and a melt flow rate as measured at 230° C. and a load of 21.2 N of 400 g/10 min;

(2) a step of impregnating (B)a continuous filler with the molten mixture of the components (A) and (C) obtained in step (1) so that a content of the component (B) becomes from 1 to 80 parts by weight based on 100 parts by weight of a combined content of the components (A), (B) and (C), thereby forming a continuous strand; and

(3) a step of cutting the continuous strand formed in step (2).

The form of the composite material of the present invention may be a strand-like form, sheet-like form, tabular form and pellet-like form resulting from cutting a strand into a proper length. In particular, for applying to injection molding, it is preferable that the composite material be in the form of a pellet having a length of from 2 to 50 mm from the viewpoint of mechanical strength of a resulting molded article or production stability during its molding.

The composite material of the present invention can be processed into a molded article with a desired shape by injection molding, extrusion forming, blow molding, or the like.

In particular, a molded article obtained by molding a composite material of the present invention containing fibers having a weight-average length of from 2 to 50 mm as the filler (B), the molded article containing fibers having a weight-average length of from 1 to 10 mm, is superior in mechanical strength and endurance. Such a molded article can be produced by subjecting the above-mentioned composite material of the present invention to injection molding under processing conditions appropriately selected based on ordinary knowledge of a person skilled in the art. The processing conditions to be taken into consideration include the type and dimensions of a screw of an injection molding machine, a diameter of an injection nozzle, a back pressure applied during plastication in an injection molding machine, and the like.

### EXAMPLES

The present invention is illustrated below by reference to Examples, which, however, do not limit the scope of the present invention.

The compositions of the samples used in Examples and Comparative Examples are shown in Table 1.

The method for producing the samples for evaluations used in Examples and Comparative Examples is described below.

(1) Method for preparing long-fiber-containing resin pellet

A long-fiber-containing resin pellet was prepared by the method described in JP-A-3-121146. The preparation was carried out at an impregnation temperature of 270° C. at a take-up rate of 20 ft/min. The glass fibers used had a diameter of 16 μm.

(2) Method for preparing samples for evaluations

A sample for evaluation was prepared by injection molding the resulting long-fiber-containing resin pellet under the following conditions using a molding machine manufactured by The Japan Steel Works, Ltd., shown below.

[Molding machine manufactured by The Japan Steel Works, Ltd.]

Clamping force: 150 t

Screw: Screw with a deep channel

Screw diameter: 46 mm

Screw L/D: 20.3

[Molding conditions]

Cylinder temperature: 250° C.

Mold temperature: 50° C.

Back pressure: 0 MPa

The methods for evaluations of physical properties of the samples in Examples and Comparative Examples are as follows.

(1) Maleic anhydride-graft amount (unit: % by weight)

In 100 ml of xylene, 1.0 g of a sample was dissolved. The solution was dropped to 1000 ml of methanol under stirring and a solid formed was recovered. The above-mentioned operation from dissolution to recovery is hereafter referred to as purification. The recovered solid was vacuum dried (80° C., 8 hours) and then hot pressed to form a film 100 μm thick. The film was measured for its infrared spectrum. A maleic anhydride-graft amount was determined from an absorption near 1780 cm⁻¹ according to the method described by Fumio IDE et al., “High Polymer Chemistry”, Vol. 25, 107-115 (1968).

(2) MFR (unit: g/10 min)

Melt flow rate was measured according to ASTM D792 under the following conditions.

Measuring temperature: 230° C.

Load: 21.2 N

(3) Flexural modulus (unit: MPa)

Flexural modulus was measured according to ASTM D790 under the following conditions.

Measuring temperature: 23° C.

Sample thickness: 6.4 mm

Span: 100 mm

Tensile rate: 2 mm/min

(4) Flexural strength (unit: MPa)

Flexural strength was measured according to ASTM D790 under the following conditions.

Measuring temperature: 23° C.

Sample thickness: 6.4 mm

Span: 100 mm

Tensile rate: 2 mm/min

(5) IZOD impact strength (unit: KJ/m²)

IZOD impact strength was measured according to ASTM D256 under the following conditions.

Measuring temperature: 23° C.

Sample thickness: 6.4 mm (with a V notch)

(6) Fatigue strength

Measurement was carried out according to a cantilever bending test, ASTM D671-71T METHOD B. Fatigue strength was evaluated based on the number of repetitions until rupture.

Test machine: Repeated Vibration Fatigue Tester (Model B70TH) manufactured by Toyo Seiki Seisaku-syo, LTD.

Shape of specimen: TYPE A

Measuring temperature: 23° C.

Repeating rate: 30 Hz

Loaded stress: 45 MPa, 50 MPa

(7) Quantitation of remaining maleic anhydride

A film 100 μm thick was obtained by hot pressing a modified polypropylene resin before being subjected to the purification carried out in the determination of the maleic anhydride-graft amount by the procedure (1) described previously. The film was measured for its infrared spectrum and a combined amount (unit: % by weight) of the remaining maleic anhydride and the grafted maleic anhydride in the film was determined based on an absorption near 1780 cm⁻¹. A value obtained by subtracting the maleic anhydride-graft amount determined by the procedure (1) from the above-mentioned combined amount was used as an amount of the remaining maleic anhydride.

(8) Weight-average length of fibers

Weight-average length of fibers was determined by the method described in JP-A-2002-5924.

### EXAMPLE 1

To 100 parts by weight of an ethylene-propylene block copolymer (intrinsic viscosity [η]=2.8 (dl/g), EP content=21% by weight), 1.0 part by weight of maleic anhydride, 0.50 part by weight of dicetyl peroxydicarbonate, 0.15 part by weight of 1,3-bis(tert-butylperoxydiisopropyl)benzene, 0.05 part by weight of calcium stearate, and 0.3 part by weight of an antioxidant tetrakis[methylene-3-(3,5-di-tert-butyl-4-hydroxyphenyl) propionate]methane were added and fully mixed preliminarily in a Henschel mixer. Then the mixture was fed to a single screw extruder and was melt-kneaded to form a modified polyolefin resin (A-1). The temperature at which diacetyl peroxydicarbonate has a half-life of 1 minute is 99° C. and the temperature at which 1,3-bis (tert-butylperoxydiisopropyl)benzene has a half-life of 1 minute is 183° C. The maleic anhydride-graft amount and MFR of the resulting modified polyolefin resin (A-1) are shown in Table 1. The modified polyolefin resin (A-1) contained maleic anhydride in an amount of 0.3% by weight. The single screw extruder used was a single screw extruder EXT-90 (L/D=36, cylinder diameter 90 mm) manufactured by Isuzu Kakoki, Co., Ltd. The cylinder temperature was set to 180° C. for the first half and to 250° C. for the second half. The rate of screw rotation was 133 rpm.

A pellet having a composition shown in Table 1, a glass fiber content of 40% by weight and a length of 9 mm was prepared by the method described in JP-A-3-121146. The resulting pellet was subjected to injection molding and a sample formed was measured for flexural modulus, flexural strength, IZOD impact strength and fatigue strength. The results are shown in Table 1. The fibers contained in the sample used for the evaluations had a weight-average length of 5 mm.

### COMPARATIVE EXAMPLE 1

A modified polyolefin resin (A-2) was obtained by conducting the same operation as EXAMPLE 1 except changing the addition amount of 1,3-bis (tert-butylperoxydiisopropyl)benzene from 0.15 part by weight to 0.05 part by weight and using no dicetyl peroxydicarbonate. The maleic anhydride-graft amount and MFR of the resulting polyolefin resin (A-2) are shown in Table 1. The modified polyolefin resin (A-2) contained maleic anhydride in an amount of 0.1% by weight.

A pellet and a sample were prepared in the same manners as Example 1 in a composition shown in Table 1 and the physical properties thereof were measured. The results are shown in Table 1. The fibers contained in the sample used for the evaluations had a weight-average length of 5 mm.

### COMPARATIVE EXAMPLE 2

A pellet and a sample were prepared in the same manners as Example 1 in a composition shown in Table 1 except changing the modified polyolefin resin used in EXAMPLE 1 to PB3000 manufactured by Crompton Corp. [modified polyolefin resin (A-3)] and the physical properties thereof were measured. The results are shown in Table 1. The maleic anhydride-graft amount and MFR of the PB3000 manufactured by Crompton Corp. [modified polyolefin resin (A-3)] are shown in Table 1. The modified polyolefin (A-3) was free of maleic anhydride. The fibers contained in the sample used for the evaluations had a weight-average length of 5 mm.

### EXAMPLE 2

A modified polyolefin resin described in EXAMPLE 2 in JP-A-2002-20436 was used as (A-4). The maleic anhydride-graft amount and MFR of the modified polyolefin resin (A-4) are shown in Table 1. The modified polyolefin (A-4) was free of maleic anhydride.

A pellet and a sample were prepared in the same manners as Example 1 in a composition shown in Table 1 and the physical properties thereof were measured. The results are shown in Table 1. The fibers contained in the sample used for the evaluations had a weight-average length of 5 mm.

TABLE 1

| | | | |
|---|---|---|---|
| | COMPARATIVE | COMPARATIVE | |
| EXAMPLE 1 | EXAMPLE 1 | EXAMPLE 2 | EXAMPLE 2 |

Composition

| | | | | | |
|---|---|---|---|---|---|
| (A) | Modified polyolefin | A-1 | A-2 | A-3 | A-4 |
| | resin | | | | |
| | Amount (p.b.w.) | 6 | 6 | 2.3 | 6 |
| (B) | Fiber | B-1 | B-1 | B-1 | B-1 |
| | Amount (p.b.w.) | 40 | 40 | 40 | 40 |
| (C) | Polyolefin resin | C-1 | C-1 | C-1 | C-1 |
| | Amount (p.b.w.) | 54 | 54 | 57.7 | 54 |

Particulars of (A)

| | | | | |
|---|---|---|---|---|
| Maleic anhydride- | 0.64 | 0.20 | 1.6 | 0.82 |
| graft amount (wt %) | | | | |
| MFR (g/10 min) | 70 | 42 | 500 or more | 350 |

Result of evaluation

| | | | | |
|---|---|---|---|---|
| Flexural modulus (MPa) | 6700 | 6690 | 6910 | 6980 |
| Flexural strength (MPa) | 153 | 150 | 163 | 159 |
| IZOD impact strength | 34 | 28 | 28 | 34 |
| (kJ/m²) | | | | |
| Fatigue strength (cycles) | 336978 | 288530 | 136886 | 471568 |
| [load stress = 45 MPa] | | | | |
| Fatigue strength (cycles) | 55382 | 111586 | 74142 | 179756 |
| [load stress = 50 MPa] | | | | |

B-1: Glass fiber (diameter = 16 μm)
C-1: Propylene homopolymer (MFR = 80 g/10 min)

It is clear that Examples 1 and 2, in which the requirements of the present invention are satisfied, are superior in stiffness (flexural modulus and flexural strength) and impact strength (IZOD impact strength) and also in fatigue strength.

In contrast, it is also clear that in both Comparative Example 1 in which the graft amount requirement of the present invention for a modified polyolefin resin is not met and Comparative Example 2 in which the MFR requirement of the present invention is not met, the fatigue strength is insufficient.

As described in detail above, the present invention can afford composite materials and molded articles superior in mechanical strength, e.g. stiffness and impact strength, and in endurance, e.g. fatigue strength.

What is claimed is:

1. A composite material comprising (A) a modified polyolefin resin graft-modified with an unsaturated carboxylic acid and/or its derivative and (B) a filler, wherein a content of the component (B) is from 1 to 80 parts by weight based on 100 parts by weight of a combined content of the components (A) and (B), a graft amount of the unsaturated carboxylic acid and/or its derivative in the component (A) is 0.3% by weight or more, and the component (A) has a melt flow rate as measured at 230° C. and a load of 21.2 N of 400 g/10 min or less.

2. The composite material according to claim 1, wherein the filler (B) is fiber.

3. The composite material according to claim 1, wherein the filler (B) is glass fiber.

4. The composite material according to claim 2, wherein the fiber has a weight-average length of 2 to 50 mm.

5. The composite material according to claim 1, wherein the modified polyolefin resin (A) is a modified polypropylene resin.

6. The composite material according to claim 2, wherein the composite material is in the form of pellet having a length equal to a weight-average length of the fibers contained in the pellet.

7. A molded article obtained by molding the composite material according to claim 1.

8. A molded article obtained by molding the composite material according to claim 4, wherein the fibers in the molded article has a weight-average length of 1 to 10 mm. A

9. A method for producing a composite material comprising the steps (1) to (3) defined below:
(1) a step of melt kneading (A) a modified polyolefin resin graft-modified with an unsaturated carboxylic acid and/or its derivative, the modified polyolefin resin having a graft amount of the unsaturated carboxylic acid and/or its derivative of 0.3% by weight or more and a melt flow rate as measured at 230° C. and a load of 21.2 N of 400 g/10 min;
(2) a step of impregnating (B) a continuous filler with the molten component (A) obtained in step (1) so that a content of the component (B) becomes from 1 to 80 parts by weight based on 100 parts by weight of a combined content of the components (A) and (B), thereby forming a continuous strand; and
(3) a step of cutting the continuous strand formed in step (2).

10. A composite material comprising (A) a modified polyolefin resin graft-modified with an unsaturated carboxylic acid and/or its derivative,. (B) a filler and (C) a polyolefin resin, wherein a weight ratio of the component (C) to the component (A) is from 99.9/0.1 to 60/40, a content of the component (B) is from 1 to 80 parts by weight based on 100 parts by weight of a combined content of the components (A), (B) and (C), a graft amount of the unsaturated carboxylic acid and/or its derivative in the component (A) is 0.3% by weight or more, and the component (A) has a melt flow rate as measured at 230° C. and a load of 21.2 N of 400 g/10 min or less.

11. The composite material according to claim 10, wherein the filler (B) is fiber.

12. The composite material according to claim 10, wherein the filler (B) is glass fiber.

13. The composite material according to claim 11, wherein the fiber has a weight-average length of 2 to 50 mm.

14. The composite material according to claim 10, wherein the polyolefin resin (C) is a polypropylene resin.

15. The composite material according to claim 10, wherein the modified polyolefin resin (A) is a modified polypropylene resin.

16. The composite material according to claim 11, wherein the composite material is in the form of pellet having a length equal to a weight-average length of the fibers contained in the pellet.

17. A molded article obtained by molding the composite material according to claim 10.

18. A molded article obtained by molding the composite material according to claim 13, wherein the fibers in the molded article has a weight-average length of 1 to 10 mm.

19. A method for producing a composite material comprising the steps (1) to (3) defined below:
(1) a step of melt kneading (A) a modified polyolefin resin graft-modified with an unsaturated carboxylic acid and/or its derivative and (C) a polyolefin resin so that a weight ratio of the component (C) to the component (A) becomes from 99.9/0.1 to 60/40, the modified polyolefin resin (A) having a graft amount of the unsaturated carboxylic acid and/or its derivative of 0.3% by weight or more and a melt flow rate as measured at 230° C. and a load of 21.2 N of 400 g/10 min;
(2) a step of impregnating (B) a continuous filler with the molten mixture of the components (A) and (C) obtained in step (1) so that a content of the component (B) becomes from 1 to 80 parts by weight based on 100 parts by weight of a combined content of the components (A), (B) and (C), thereby forming a continuous strand; and
(3) a step of cutting the continuous strand formed in step (2).
